(19) United States
(12) Patent Application Publication
(10) Pub. No.: US 2020/0070956 A1
(43) Pub. Date: Mar. 5, 2020

(54) Aerodynamic Regulation of Airscrew-, Fan- and Wind Turbine Blades with Bores and/or Cutting and/or Notching

(71) Applicants: Attila NYÍRI, Esztergom (HU); Róbert CÍRUS, Esztergom (HU); Norbert CÍRUS, Esztergom (HU)

(72) Inventors: Attila NYÍRI, Esztergom (HU); Róbert CÍRUS, Esztergom (HU); Norbert CÍRUS, Esztergom (HU)

(21) Appl. No.: 16/062,698

(22) PCT Filed: Apr. 4, 2017
(86) PCT No.: PCT/HU2017/000026

§ 371 Date: Jun. 23, 2018

(30) Foreign Application Priority Data
Sep. 7, 2016 (HU) P 16 00523

(51) Int. Cl. B64C 11/18; F01D 5/14; F03D 1/06

(52) U.S. Cl. CPC B64C 11/18; F01D 5/146; B64C 2230/28; F01D 5/145; F03D 1/0633

(57) ABSTRACT

Axial airplane airscrew-, fan-, and wind turbine blade of low loading characterised by the fact that the aspect ratio of the airscrew-, fan- and wind turbine blades is low; near to the wide blade ends, but in an appropriate distance an aperture of appropriate length and width—almost parallel to the side of the blade end—is formed, which connects the surfaces of lower and higher pressure. When being operated, the air flowing through this aperture eliminates the turbulence formed at the end of the blades.

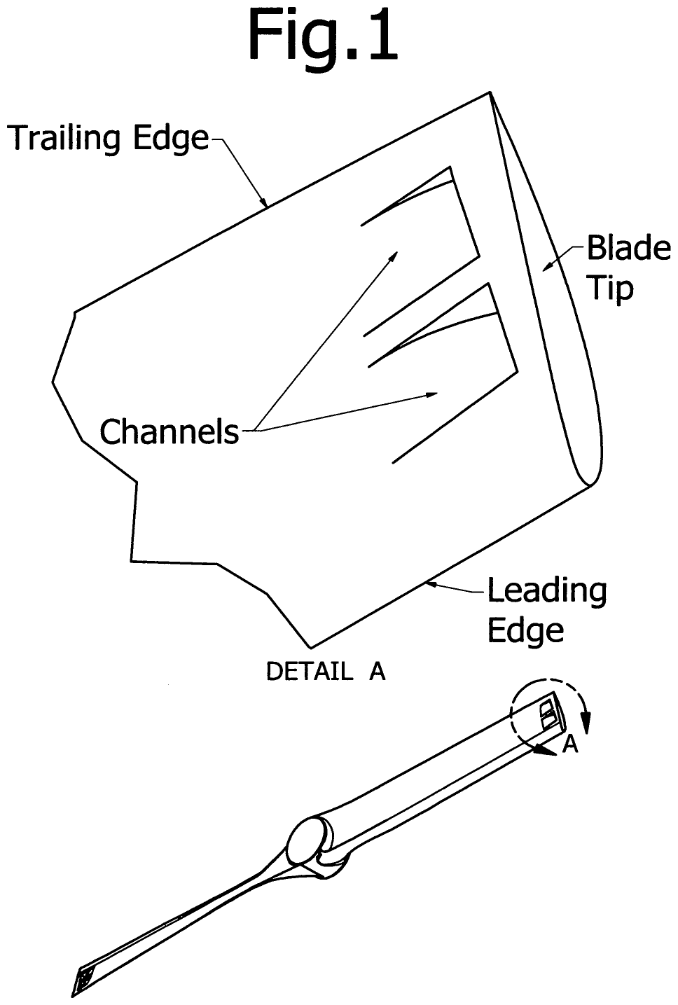

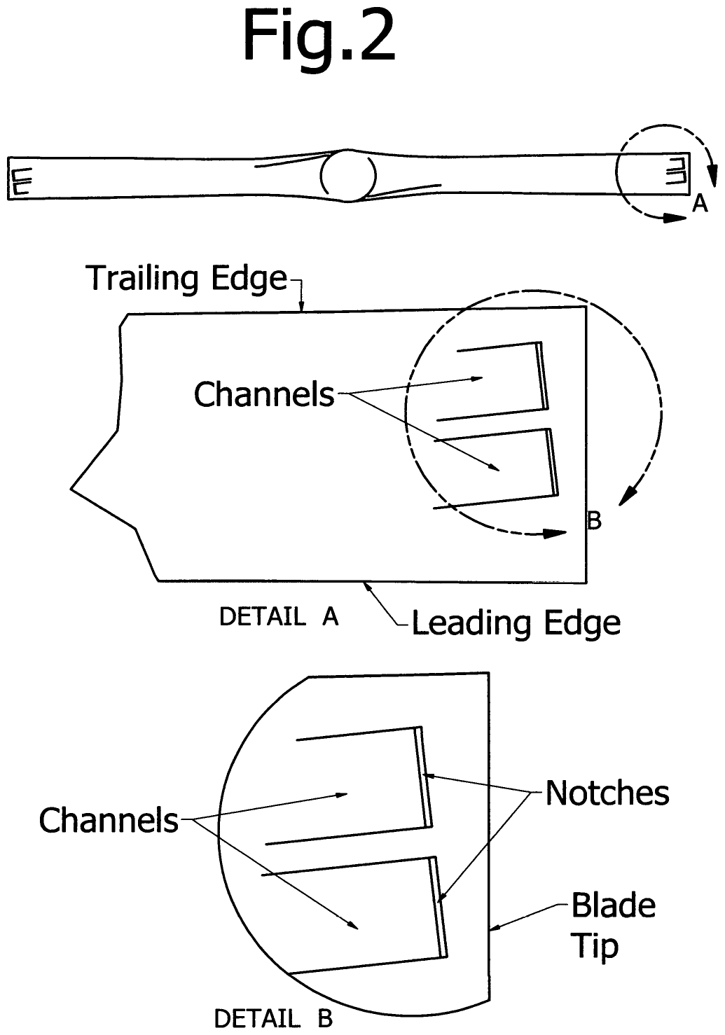

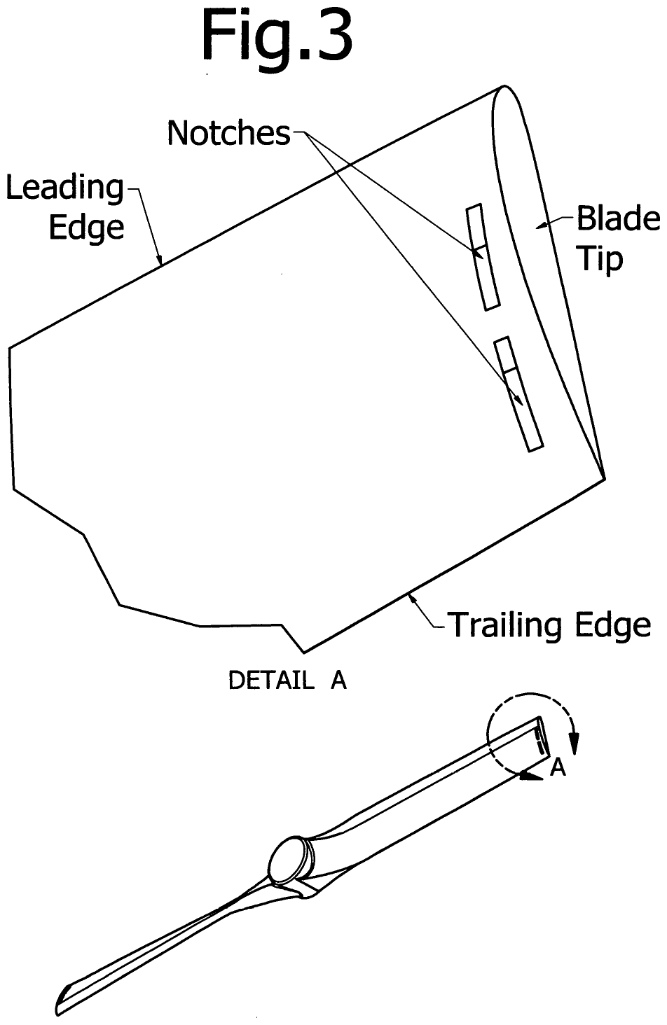

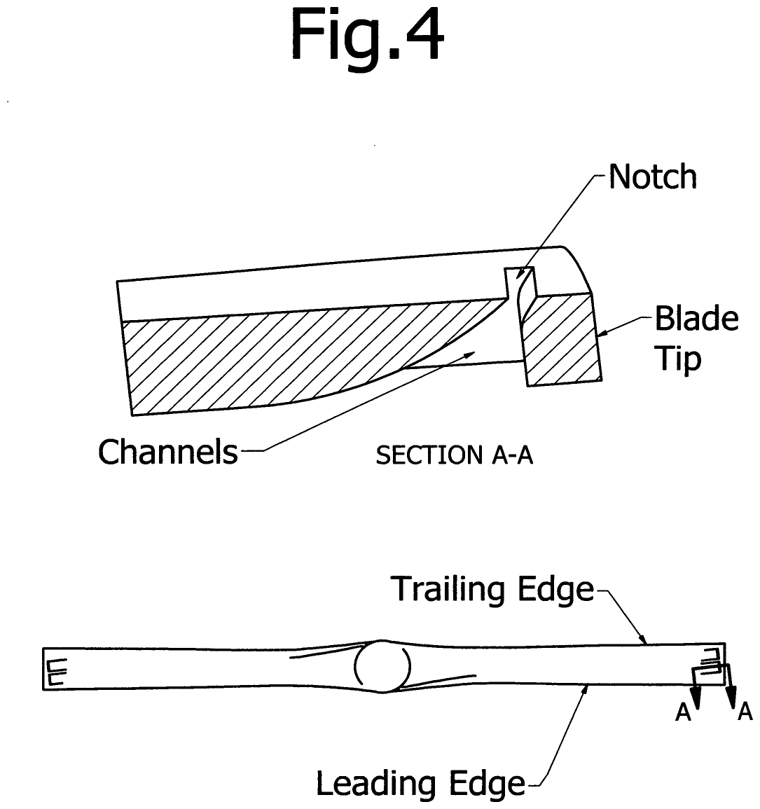

With regards to diameter, the choice of the distribution of strings on the airscrew blade (its blade width) caused problems in case of adapting a huge performance, as well as there was a need to form wide blade ends. The losses resulting from the circular flow of the blade ends were, however, increased dramatically.

In case of adapting wide blade ends, the invention uses the phenomenon known from physics as interference, more precisely whirl interference to reduce or eliminate the loss of potential resulting from the circular flow of the blade ends tips on the airscrew.

A whirl of contrary direction and of equal angular momentum (or impulse momentum) is induced at the ends of the airscrew blades, which by this eliminates or significantly reduces the whirls appearing at the end of wide blades and causing losses.

As a result of this, a tractive force evolves on the airscrews and the range of action of the aircraft as well as the time spent on flying can be increased.

Its application is also recommended on wind turbine rotor blades.

If applied, it reduces the resonant vibrations occurring on the blades and the turbines, and thus extending their lifetime significantly. Using aerodynamic braking the forming of the pivoting tip is more effective and less vibrating. The blade edges are working as slotted flaps.

### 1. THE SUBJECT OF THE INVENTION

The pressure distribution of airscrew-, fan-, and wind turbine blades, and by this the determination of flow characteristics are solved by means of linking the areas of different pressure (low and high) on the blades with bores and/or cutting and/or notching.

The original pressure characteristics are changed due to the flow resulting from the pressure difference in the bores, cuts or notches. These changes are of such nature that on the blades (from a physical and technical point of view) the emergence of unfavourable turbulences is reduced or eliminated. The solution can be used on tools of any desired size.

One way for realisation is when close to the end of the blade, but on a point which is in an appropriate distance from it, a cut of appropriate width and almost parallel to the end of the blade can be shaped. The air flowing through this aperture eliminates the air turbulence otherwise occurring on the end of the blades.

### 2. THE DEVELOPMENT STATE OF THE TECHNOLOGY

According to the present state of knowledge of declarers no such airscrew, fan, or wind turbine exists in the world and no distributors, manufacturers or investigations are known in this field.

Similarly to airplane wings only in order to prevent the separation of flow—the forming of turbulent flow—an aperture would be applied close to the trailing edge. No practical realisation is known in this respect.

1. Air screw-, fan-, and wind turbine blades with wide blade tip for use in an axial flow rotor stage, having a body with pressure and suction surfaces on opposite sides of the blade, a span extending between a root and a tip and a chord extending between a leading edge and a trailing edge, characterised in that formed in the end tip of the blade is a notch which extends between the pressure and suction sides, and a channel leading to the notch—on the pressure side—formed through the body of the blade between said pressure and suction surfaces, wherein the distance between the end tip of the blade and the notch changes in its diameter from 1.2% to 1.67% along the length of the hole.

2. Air screw-, fan-, and wind turbine blades with wide blade tip as claimed in claim 1 wherein the notch—for ensuring strength—can be divided to sections with small interruptions.

3. Air screw-, fan-, and wind turbine blades with wide blade tip as claimed in claim 1 or claim 2 wherein the notch forms a radian angle of 0.139623 with the radius.

4. Air screw-, fan-, and wind turbine blades with wide blade tip as claimed in claim 3 wherein the length of the notch is approximately 60% of the length of the tip of the blade.

5. Air screw-, fan-, and wind turbine blades with wide blade tip as claimed in any preceding claim wherein the width of the notch is 3.53% of the length of the notch.

6. Air screw-, fan-, and wind turbine blades with wide blade tip as claimed in any preceding claim wherein the root of the notch is formed near the trailing edge.
